(19) United States
(12) Patent Application Publication
(10) Pub. No.: US 2008/0100471 A1
(43) Pub. Date: May 1, 2008

(54) COLORED LIGHT EMITTING DIODE PICTURE AND LITERARY COMPOSITION SIGNAL DISPLAY DEVICE

(76) Inventors: CHEN CHANG, Taipei City (TW); Toung-Tai Chiang, Taipei City (TW)

Correspondence Address: LEONG C LEI, PMB # 1008, 1867 YGNACIO VALLEY ROAD, WALNUT CREEK, CA, 94598, US

(21) Appl. No.: 11/877,673

(22) Filed: Oct. 24, 2007

(30) Foreign Application Priority Data
Nov. 1, 2006 (TW) 095219271

(51) Int. Cl. G09F 9/33

(52) U.S. Cl. 340/815.45; 340/907

(57) ABSTRACT

The signal display device has a single lamp made up of a number of colored LEDs, each capable of emitting at least red, green, and yellow light separately so as to replace the conventional three-lamp signal display device. Each of the LEDs of the signal display device can be selectively controlled to emit a specific colored light individually and independently. Therefore, for example, a number of specific LEDs forming a text or picture can be turned on to emit yellow light while the rest of the LEDs are turned on to emit red or green light.

### TECHNICAL FIELD OF THE INVENTION

The present invention generally relates to signal display devices for traffic control, and more particularly to a signal display device containing a large number of light emitting diodes that can be selectively controlled to emit a specific colored light individually and independently.

### DESCRIPTION OF THE PRIOR ART

As shown in FIG. 13, a conventional signal display device for traffic control usually contains three separate lamps for illuminating red, green, and yellow light, respectively.

Even though the conventional signal display device for traffic control has been used for many years, it can be improved in many ways. For example, actually, a single lamp capable of illuminating red, green, and yellow light separately can replace the three separate lamps with significant lower cost and power consumption. On the other hand, if literary text or graphic picture is to be integrated in the signal display device (for example, showing a countdown clock), separate lamps have to be installed.

Furthermore, recently, the advancement in light emitting diodes (LEDs) both in terms of brightness and operational life (e.g. up to 50,000 hours) has made the LED a promising light source for the signal display device. The power consumption of LEDs is only up to one tenth of the conventional light bulb. The LEDs also produce less heat and therefore is friendlier to the environment.

### SUMMARY OF THE INVENTION

Accordingly, a major purpose of the present invention is to provide a signal display device having a single lamp made up of a number of colored LEDs so as to achieve more cost effectiveness and power saving than the conventional three-lamp signal display device. To achieve this purpose, the signal display device contains a large number of LEDs, each capable of emitting at least red, green, and yellow light separately.

Another major purpose of the present invention is to provide a signal display device capable of displaying text or picture within the control light to guide, direct, or alert the drivers or the pedestrians. To achieve this purpose, each of the LEDs of the signal display device can be selectively controlled to emit a specific colored light individually and independently. Therefore, for example, a number of specific LEDs forming a text or picture can be turned on to emit yellow light while the rest of the LEDs are turned on to emit red or green light.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a sectional view showing a signal display device according to an embodiment of the present invention.

FIG. 2 is a front view showing the signal display device of FIG. 1.

FIG. 3 is an application of the signal display device of FIG. 1 in displaying a countdown clock.

FIGS. 4 to 9 are front views of the signal display device of FIG. 1 where the LEDs are packed differently in accordance with the cross section of the LEDs.

FIG. 10 is a front view showing a signal display device according to another embodiment of the present invention.

FIG. 11 is a front view showing a signal display device according to yet another embodiment of the present invention.

FIG. 12 is a schematic view showing a signal display device of the present invention installed on a post.

FIG. 13 is a schematic view showing a conventional signal display device installed on a post.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

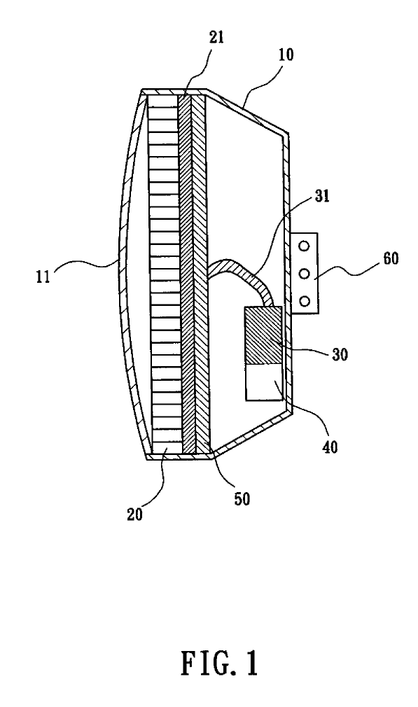

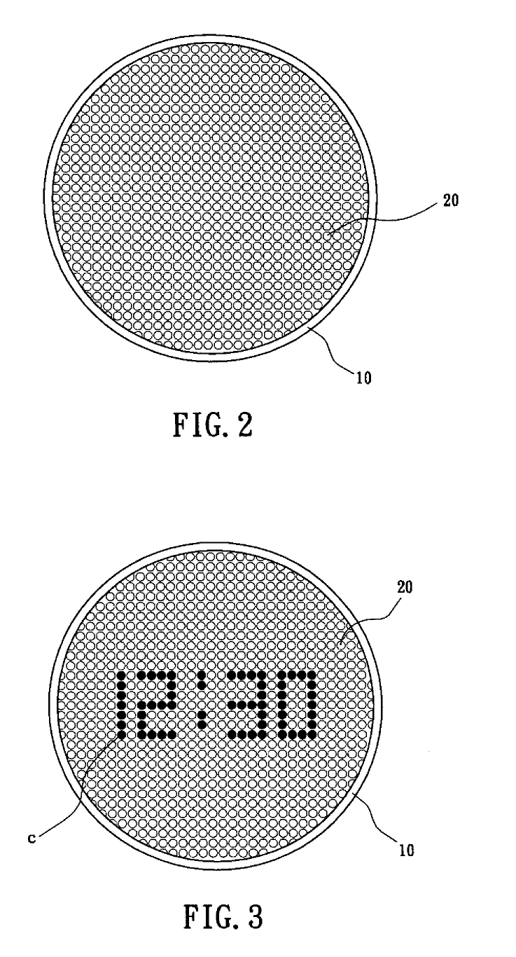

As shown in FIGS. 1 and 2, a signal display device according to an embodiment of the present invention contains a number of LEDs 20, a socket plate 21 for the positioning of the LEDs 20, a distribution unit 50 for distributing electricity and control signals to the LEDs via the socket plate 21, a control circuit 30 for controlling the LEDs 20, a power unit 40 for the provision of electricity, a hollow casing 10 for housing the foregoing components inside, and a connection element 60 for the positioning and fixation of the signal control device.

The casing 10 has a transparent front cover 11 sealing the rest of the components (except the connection element 60) inside the casing 10 but allowing the light of the LEDs 20 to pass through. The casing 10 usually has a circular front surface but any other appropriate geometric shape is also possible.

Each LED 20 is capable of emitting at least red, green, and yellow light separately and has a cylindrical shape so that a large number of LEDs 20 can be packed together inside the casing 10 to produce brighter and more vivid traffic light. Each LED 20 is electrically positioned on the socket plate 21 and the socket plate 21 conducts electricity and control signals to the LED 20 for its turning on/off and for selecting the color of light.

The control circuit 30 is connected to the distribution unit 50 by a cable 31. The control signals issued by the control circuit 30 are delivered to the LEDs 20 via the cable 31, the distribution unit 50, and the socket plate 21.

The power unit 40 is also connected to the distribution unit 50 via the cable 31 so as to deliver the required electricity to the LEDs 20.

The socket plate 21 contains a number of sockets (not shown), each for the installation of a LED 20. The sockets provide easy and direct replacement of the faulty LEDs 20. The socket plate 21 conducts electricity and control signal from the distribution unit 50 to the LEDs 20 individually and independently.

The connection element 60 is fixedly positioned on the outer surface of the casing 10 for attaching the signal display device to other objects such as a lamp post.

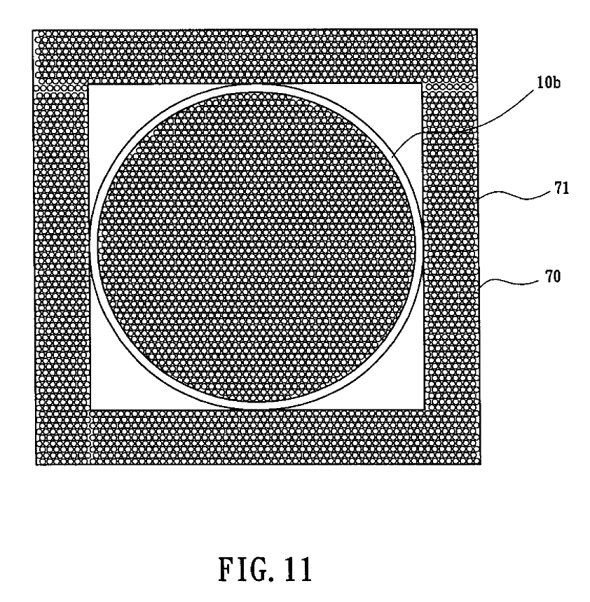

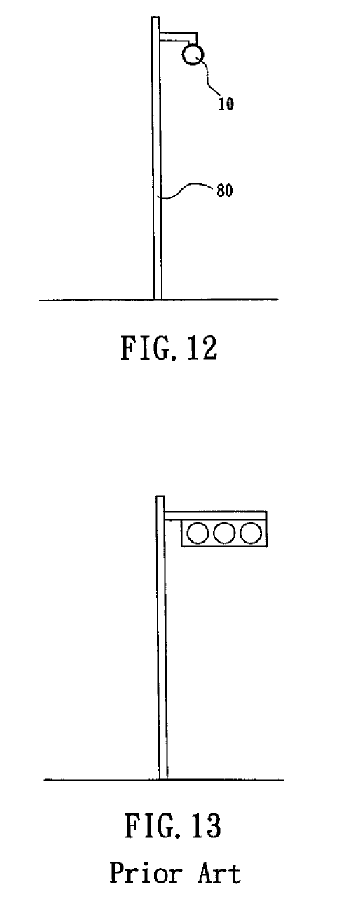

The signal display device as described above is able to emit red, green, and yellow light separately by itself. As shown in FIG. 12 and in contrast to the conventional signal display device of FIG. 13, the signal display device of the present invention can be installed solely on a post SO by the connection element 60 to replace the convention three-lamp signal display device. Together with the adoption of power-saving LEDs, the signal control device is also more cost effective and environment friendlier.

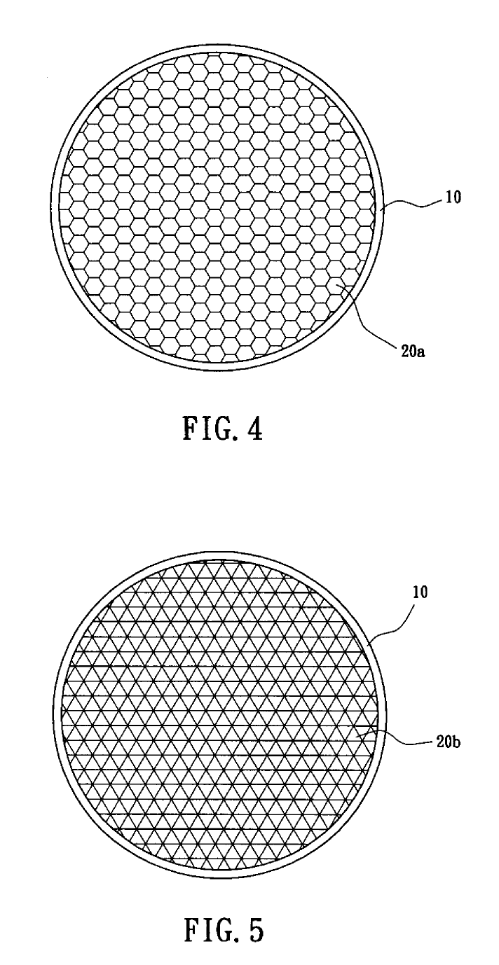

As shown in FIG. 3, the control circuit 30 can make a number of specific LEDs 20 of the signal control device to emit a colored light different from the rest of the LEDs 20 so as to present a text (such as the digits shown) or a graphic picture. For example, the LEDs 20 making up the text or picture are turned on to emit yellow light while the rest of the LEDs 20 are turned on to emit red or green light. Similarly, the LEDs 20 making up the text or picture can be turned on to emit white light while the rest of the LEDs 20 are turned on to emit yellow light. These color combinations are only exemplary and various other possible combinations are also possible.

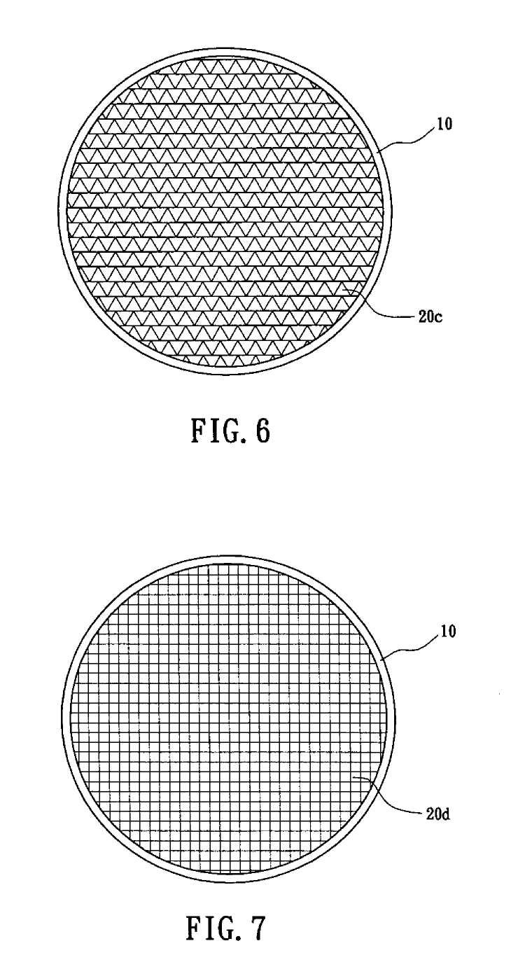

The LEDs 20 has a cylindrical shape. The LEDs 20 can have various different cross sections and therefore are packed differently together. Please note that there could be an appropriate gap between any two adjacent LEDs 20. For example, as shown in FIG. 4, the LEDs 20a can have a hexagonal cross section and the LEDs 20a are packed like a honeycomb. Similarly, as shown in FIGS. 5 and 6, the LEDs 20b and 20c have a triangular cross section but are packed differently. As shown in FIGS. 7 to 9, the LEDs 20d, 20e, and 20f all have a rectangular cross section but with different dimensions. Again, the geometric shape of the cross sections of the LEDs and the way the LEDs are arranged together are not limited to those described above.

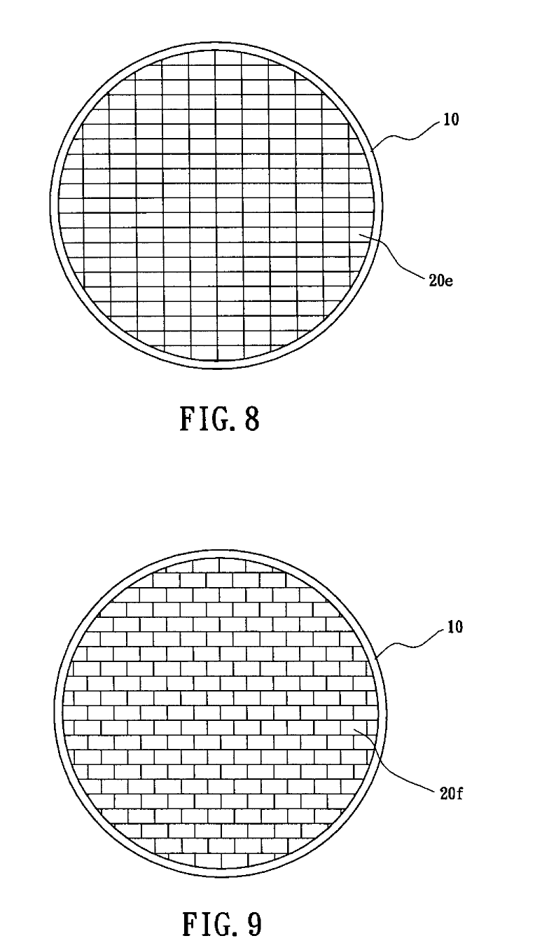

FIG. 10 shows another embodiment of the present invention. Unlike the previous embodiments where the text or picture is integrated with the control light the present embodiment has the LEDs 20g within the casing 10a physically separated into a rectangular area specifically for the display of text or picture and another circular area specifically for the control light.

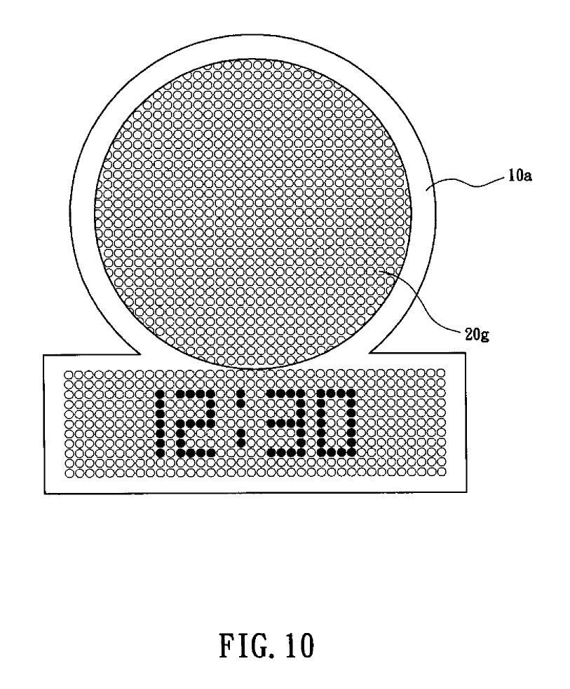

FIG. 11 shows yet another embodiment of the present invention. As illustrated, the LEDs within the casing 10b are dedicated to the control light and an auxiliary display area 70 with a number of colored LEDs 71 is provided for the text or picture. With the larger display area 70, flexible display effect such as running text or picture can be achieved.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A signal display device, comprising:
a hollow casing;
a plurality of LEDs housed inside said casing, each capable of emitting at least red, green, and yellow light separately;
a control circuit housed inside said casing electrically and signally connected to said LEDs; and
a power unit housed inside said casing electrically connected to said control circuit and said LEDs for the provisioning of electricity; wherein said control circuit controls each of said LEDs to emit a specific colored light independently and individually.

2. The signal display device according to claim 1, wherein said casing has a transparent front cover allowing the light of said LEDs to pass through.

3. The signal display device according to claim 1, wherein said casing has a circular front surface.

4. The signal display device according to claim 1, wherein said LEDs has a cylindrical shape with a hexagonal cross section.

5. The signal display device according to claim 1, wherein said LEDs has a cylindrical shape with a triangular cross section.

6. The signal display device according to claim 1, wherein said LEDs has a cylindrical shape with a rectangular cross section.

7. The signal display device according to claim 1, wherein there is an appropriate gap between any two adjacent LEDs.

8. The signal display device according to claim 1, further comprising a socket plate for the positioning of said LEDs wherein said socket plate conducts electricity from said power unit and control signals from said control circuit to said LEDs individually and independently.

9. The signal display device according to claim 1, further comprising a connection element attached to the outer surface of said casing.

10. The signal display device according to claim 9, wherein said signal display device is installed on a post by said connection element.

11. The signal display device according to claim 1, wherein a text or picture is presented by said signal display device by controlling a specific plurality of LEDs to emit a colored light different from that of the rest of said LEDs.

12. The signal display device according to claim 11, wherein said specific plurality of LEDs are dispersed among the rest of said LEDs.

13. The signal display device according to claim 11, wherein said specific plurality of LEDs are physically separated from the rest of said LEDs.

14. The signal display device according to claim 1, further comprising an auxiliary display area having a plurality of colored LEDs positioned around said casing.
